(19) United States
(12) Patent Application Publication
(10) Pub. No.: US 2026/0015083 A1
(43) Pub. Date: Jan. 15, 2026

(54) ELECTRIC VERTICAL TAKE-OFF AND LANDING AIRCRAFT

(71) Applicant: DUFOUR AEROSPACE AG, Visp (CH)

(72) Inventors: Simon BENDREY, Gränichen (CH); Manuel FLEPP, Wädenswil (CH); Jasmine KENT, Zurich (CH); Felix RUBIN, Spiez (CH); Thomas PFAMMATTER, Visp (CH); Dominique STEFFEN, Brig (CH)

(21) Appl. No.: 18/994,022

(22) PCT Filed: Aug. 12, 2022
(86) PCT No.: PCT/EP2022/072706

§ 371 Date: Jan. 13, 2025

(51) Int. Cl. B64C 29/00; B64C 9/08; B64C 11/30; B64C 13/16; B64D 27/34

(52) U.S. Cl. CPC B64C 29/0033; B64C 9/08; B64C 11/30; B64C 13/16; B64D 27/34

(57) ABSTRACT

An electric vertical take-off and landing aircraft comprises a fuselage and a tilt wing. The tilt wing is tiltable relative to the fuselage in a range of tilt wing angles. Control surfaces are arranged at the tilt wings. The aircraft comprises a horizontal stabilizer with an elevator, in particular a stabilator, a vertical stabilizer with a rudder, in particular a fully movable stabilizer, at least one electric engine for powering main propellers arranged at the tilt wing and at least one software control device. The control device is configured to control at least the control surfaces , the main propellers and the tilt wing angle during hover and transition between hover and cruise flight.

### TECHNICAL FIELD

The invention relates to an electric vertical take-off and landing aircraft. The aircraft comprises a fuselage and a straight through tilt wing. The straight through tilt wing is tiltable relative to the fuselage in a range of tilt wing angles. Control surfaces are arranged at the tilt wings, in particular at the trailing edge. Furthermore, the aircraft comprises a horizontal stabilizer with an elevator, in particular a stabilator and a vertical stabilizer with a rudder, in particular wherein the vertical stabilizer is integral to the horizontal stabilator. Electric engines are provided for powering main propellers arranged at the tilt wing, in particular wherein each propeller has its own electric engine and each control surface has its own electric actuator.

### BACKGROUND ART

A vertical take-off and landing (VTOL) aircraft is one that can hover, take-off and land vertically without relying on a runway. VTOL includes helicopters, tiltrotor aircrafts or tiltwing aircrafts, for example. A tiltwing aircraft features a wing that is horizontal for conventional forward flight, i.e. cruise, and rotates up for vertical take-off and landing. It is similar to the tiltrotor design where only the propeller and engine rotate. A known tiltwing aircraft is Canadair CL-84 Dynavert from 1965.

The tiltwing design offers certain advantages relative to a tiltrotor. Because the slipstream from the rotor strikes the wing on its smallest dimension, the tiltwing is able to apply more of its engine power to lifting the aircraft. Another advantage of tiltwing aircraft is the ease of transition between VTOL and horizontal flight modes compared to tiltrotor aircraft.

Due to ecological and economic reasons, electrically-powered VTOL aircrafts, such as electric helicopters and unmanned aerial vehicles have been considered for certain passenger-carrying and cargo-carrying applications. Using electrical power to generate thrust and lift may help somewhat to reduce noise, but it has been proven challenging to design electric VTOL aircraft that are capable of accommodating the weight required for many applications involving the transport of passengers or cargo.

### DISCLOSURE OF THE INVENTION

The problem to be solved by the present invention is therefore to provide an electric vertical take-off and landing aircraft with an optimized control of the aircraft.

This problem is solved by the aircraft according to claim 1. According to this, an electric vertical take-off and landing (VTOL) aircraft comprises:
a fuselage,
a, in particular one, straight through tilt wing, which extends across the entire width of the aircraft from left to right. The straight through tilt wing is tiltable relative to the fuselage in a range of tilt wing angles. In particular, the range of tilt wing angles could be between 0° and 100°.
Control surfaces arranged at the straight through tilt wing, in particular ailerons, flaps or flaperons.
a horizontal stabilizer with an elevator.

This definition also comprises a fully movable aircraft stabilizer, called a stabilator. The stabilator serves the usual functions of longitudinal stability, control and stick force requirements otherwise performed by the separate parts of a conventional horizontal stabilizer and an elevator. In particular, the stabilizer can comprise a control propeller, in particular arranged at the tail of the aircraft, for controlling the aircraft. The control propeller is not a propeller for generating main thrust during cruise.
a vertical stabilizer with a rudder, in particular configured as twin tail or arranged on top of the rear fuselage, and/or in particular configured as a fully movable vertical stabilizer. In particular, the vertical stabilizer is integral to the horizontal stabilator and so moves with the stabilator. Each vertical stabilizer comprises a moveable rudder.
at least one electric engine for powering main propellers arranged at the tilt wings, in particular wherein one electric engine per propeller is provided.
at least one software control device. The control device is configured to control at least the control surfaces, the main propellers and the tilt wings during hover and transition. Transition is the phase when moving from hover to cruise or back from cruise to hover. The control device is software based and synchronizes the behaviour of the aircraft, i.e. control surfaces, propellers and tilt wings are controlled by software and synchronized by the control device.

Compared to that, a traditional tilt wing aircraft, like CL-84, was mechanically controlled. CL-84 had less manoeuvrability, because the control was limited to one single mechanical configuration. A software based control has the advantage that the aircraft can be controlled by different control schedules in every point in flight. The aircraft can be differently controlled during hover, transition and cruise. Different control schedules for different tilt wing angles are possible. The control schedule can be amended in case of failure of an aircraft component or different aerodynamic conditions. A software controlled aircraft can be controlled efficiently in every phase of flight. In particular, such an aircraft does not comprise gearboxes or drive shafts.

Advantageously, the control device is configured to control the tilt wing angle during hover and transition depending on the airspeed of the aircraft. With other words, the airspeed is an input parameter for the control device to determine the tilt wing angle. Airspeed is only one input parameter. The control device can consider further input parameters for determining the tilt win angle, like measured temperature, measured pressure or the effect of a gust.

In particular, if the aircraft is piloted, the control device is configured to restrict the range of the tilt wing angle selectable by the pilot depending on the airspeed of the aircraft. For example, if the airspeed is 60 km/h, the control device limits the range of tilt wing angles to 20° until 44°. Within this range, the pilot can select the tilt wing angle but the selection of the pilot is restricted to this range.

Otherwise, if the aircraft is unpiloted, the control device is configured to select the value of the tilt wing angle depending on the airspeed of the aircraft. Since no pilot is available to select a certain tilt wing angle within a range, the control device determines one specific optimal tilt wing angle, for example 32° if the airspeed is 60 km/h.

Limiting the range of the tilt wing angle or determining the tilt wing angle for an unpiloted aircraft has the advantage that the aircraft can transit safely through the corridor from hover to cruise or back from cruise to hover. A safe transition is no longer solely in the hands of the pilot. The control device supports the pilot in order to select a safe tilt wing angle.

Advantageously, the control device is configured to control at least one control parameter during hover and transition depending on the tilt wing angle. The control device defines at least one value per control parameter, in particular two values in case of a piloted aircraft and/or one value in case of an unpiloted aircraft. If the aircraft is piloted, the control device is configured to restrict the range of the at least one control parameter selectable by the pilot depending on the tilt wing angle by defining a minimum selectable value and/or a maximum selectable value, i.e. the control device defines two values. The pilot can control every thing, but the amount of control is limited. If the aircraft is unpiloted, the control device is configured to determine one particular value for the at least one control parameter depending on the tilt wing angle.

The tilt wing angle is an input parameter for the control device to determine the control parameter. The tilt wing angle is only one input parameter. The control device can consider further input parameters for determining the control parameter, like measured temperature, measured pressure or the effect of a gust.

In particular, the control parameter could be the moving position of an aileron or another control surface, like the elevator and/or the rudder. If the control parameter is controlled depending on the tilt wing angle, the aircraft can be safely and efficiently be controlled because an optimal control parameter or an optimal range of a control parameter can be selected for every point in flight by the pilot and/or determined by the control device, in particular during hover and/or during transition between hover and cruise.

In a fixed wing aircraft, if the pilot request roll, the ailerons move. If the airspeed of the aircraft is too high, the aircraft might roll too quickly. From a certain point, the pilot cannot move the stick any further, because the air pressure counteracts. In contrast to that, the control device of the present aircraft limits the movement amount of the ailerons depending on the tilt wing angle. For example, if the tilt wings are tilt with an angle of 10°, the aircraft flies with a high airspeed and the ailerons can deflect only maximally by +/−10°. If the tilt wings are tilt with an angle of 80°, the aircraft flies with a low airspeed and the ailerons can deflect maximally by +/−30°. The limitations of the movement amount of the ailerons or other control surfaces ensure a safe flight.

Advantageously, one of the control parameters is the thrust of the main propellers. Thrust of the main propellers can be used for controlling yaw or roll. The thrust of the main propellers is controlled by the control device during transition depending on the tilt wing angle. For example, if the tilt wings are tilt with a small angle and the airspeed is high, the change of thrust due to yaw control is strongly limited in order to ensure a safe flight.

Furthermore, one of the control parameters is the thrust of a control propeller arranged at the tail of the aircraft. The thrust of the control propeller is controlled by the control device during transition depending on the tilt wing angle.

Advantageously, the minimum and the maximum value, in case of a piloted aircraft, or the particular value, in case of an unpiloted aircraft, of the at least one control parameter are differently defined at least for three different specific tilt wing angles. In particular, the values between the specific tilt wing angles are linearly interpolated. In particular, one of the at least three tilt wing angles is the tilt wing angle for cruise and one of the at least three tilt wing angles is the tilt wing angle for hover. Alternatively, the values are not interpolated but defined by a complex equation.

For example, if the aircraft is unpiloted, this schedule defines how much an aileron is deflected depending on the tilt wing angle in case the aircraft wants to roll. Defined could be a different deflection angle of the ailerons for 0° tilt wing, i.e. cruise, 30° tilt wing, 60° tilt wing, and 90° tilt wing, i.e. hover.

Deviating schedules can be provided depending on
angle of attack, i.e. the angle between the reference line of the aircraft and the airflow,
side slip, i.e. in a state in which an aircraft is moving sideways as well as forward relative to the incoming airflow,
temperature, and/or
pressure.

In particular the control device is configured to control roll during hover by modulating the thrust of the main propellers. This allows the aircraft to be easily and efficiently manoeuvred while hovering.

Advantageously, the control device is configured to control pitch during hover by modulating the control propeller arranged at the tail of the aircraft. During transition, pitch is controlled by modulating the control propeller arranged at the tail and/or the moving position of the elevator, in particular of the stabilator.

In particular, yaw is controlled during hover by modulating the moving position of the ailerons. Ailerons deflect the air flowing over the wing.

Furthermore, the control device is configured to control roll during transition by modulating the main propellers and moving position of ailerons. Modulating the main propellers allows the aircraft to roll even with low airspeed. The aircraft can be safely manoeuvred in hover or while the aircraft flies with low airspeed in transition.

In particular the control device is configured to control yaw during transition by modulating the main propellers and moving position of the rudder. The combination of modulating rudder and main propeller thrust allows to control yaw even if the aircraft flies with a low airspeed in transition.

Advantageously, the control device is configured to control the at least one control parameter during hover and transition depending on existence of a failure of an aircraft device. In particular the at least one control parameter is controlled depending on the existence of a failure of one of the control surfaces arranged at the tilt wings. If an aileron jams, the aircraft will identify this failure and the control device will change the control schedule. If each wing comprises more than one ailerons, the ailerons still working can be deflected differently for counteracting the jammed aileron. The aircraft can continue safe flight and landing post any single failure.

Other advantageous embodiments are listed in the dependent claims as well as in the description below.

### BRIEF DESCRIPTION OF THE DRAWINGS

The invention will be better understood and objects other than those set forth above will become apparent from the following detailed description thereof. Such description makes reference to the annexed drawings, wherein:

FIG. 1a shows a vertical take-off and landing (VTOL) aircraft during hover;

FIG. 1b shows the aircraft of FIG. 1a during cruise flight;

FIG. 2 shows the aircraft during cruise from another perspective;

FIG. 3 shows a diagram illustrating the transition from hover to cruise through a flight corridor; and

FIG. 4 shows a control schedule for controlling the aircraft.

### MODES FOR CARRYING OUT THE INVENTION

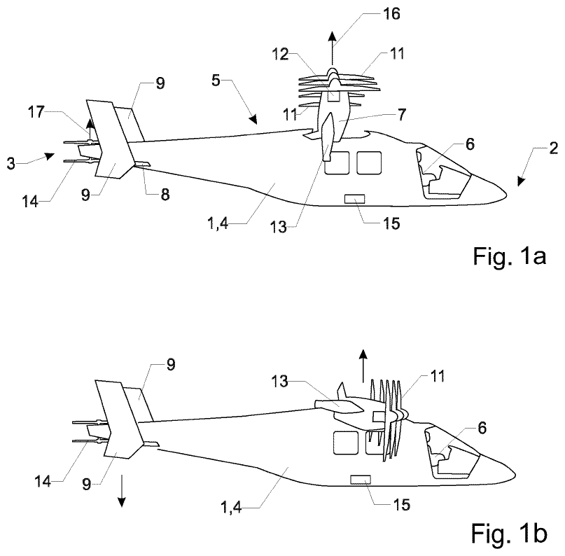

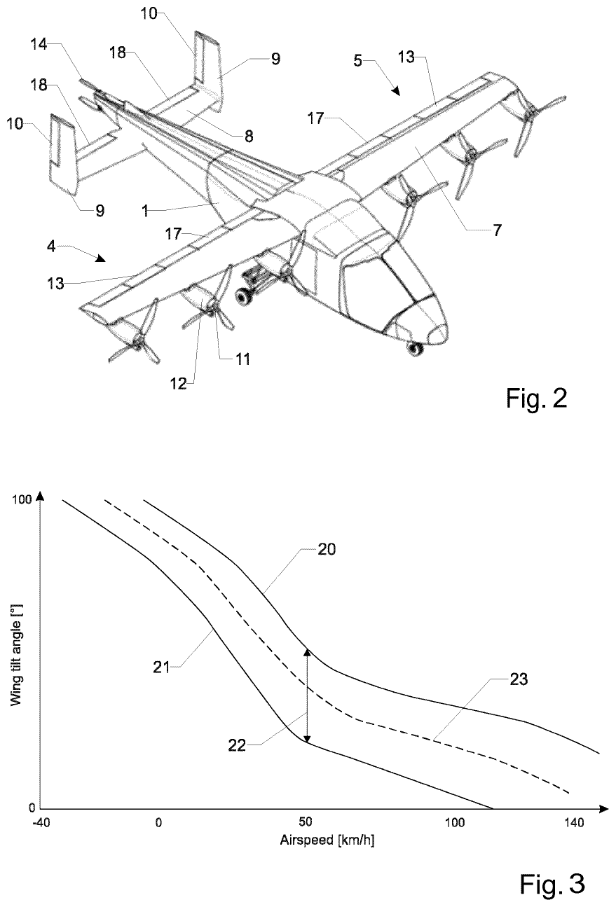

FIGS. 1a, 1b and 2 show a vertical take-off and landing (VTOL) aircraft. Such an aircraft can hover, take-off and land vertically without relying on a runway. The aircraft can transition from hover to cruise and back from cruise to hover by tilting a fully propeller washed wing. The aircraft comprises a fuselage 1 having a front 2 and a back 3. The fuselage 1 comprises a right side 4 and a left side 5. Right side 4 and left side 5 are defined from the perspective in flight direction or from the perspective of a pilot 6 if the aircraft is piloted. FIG. 1a and FIG. 1b show the right side 4 of the aircraft and the left side 5 is facing away. The aircraft comprises one straight through tilt wing 7 extending across the entire width from left to right. The tilt wing 7 has a left wing part and a right wing part. The tilt wing is hinged above the fuselage around the 45% chord position.

The aircraft comprises a horizontal stabilizer 8 with one elevator 18 on either side of the aircraft for pitch control. A pair of vertical stabilizers 9 is arranged on the horizontal stabilizer 8. The aft portion of the upper part of the vertical stabilizer 9 is movable and acts as a rudder 10.

Main propellers 11 are arranged at the front of the tilt wing 7. The left part of the tilt wing 7 comprises three main propellers 11 and the right part of the tilt wing 7 comprises three main propellers 11. The tilt wing 7 comprises six main propellers 11 in total. Each main propeller 11 is powered by an individual electric engine 12 arranged inside the tilt wing 7 next to the respective main propeller 11.

Ailerons 13 are arranged on the trailing edge of the tilt wing 7. The left part of the tilt wing 7 comprises two ailerons 13 and the right part of the tilt wing 7 comprises two ailerons 13. The tilt wing 7 comprises four ailerons 13 in total. Two or three flaps 17 are located on the inboard portion of the tilt wing on both sides of the aircraft. The flaps 17 may be employed as flaperons if required. Furthermore, a pair of tail propellers 14 is arranged at the tail of the aircraft. It serves stabilizing and controlling the aircraft and is called a control propeller.

Ailerons 13, rudders 9, flaps 17 and elevators 18 are control surfaces of the aircraft. Control surfaces, tilt wing 7, main propellers 11, and tail propellers 14 are controlled by the control device 5.

FIG. 1a shows the aircraft with the tilt wing 7 tilted to hover position. FIG. 1b and FIG. 2 show the aircraft with the tilt wing 7 tilted to cruise position. In cruise position the tilt wing 7 is tilted nearly horizontal and has a positional angle of 0°. In hover position the tilt wing 7 is tilted nearly vertical and has a positional angle of 85°, wherein the range of 80 to 90° is used for head wind trimming. However, the tilt wing 7 can be tilted between 0° and 100° tilt wing angle. From 90° to 100° the aircraft will accelerate backwards from a combination of wing lift and propeller thrust. From 0° to 80° the aircraft will accelerate forwards.

During hover, the aircraft main lifting force 16 is provided by the main wing propellers 7. The centre of gravity is located behind the main thrust line giving the aircraft a tail down and nose up pitch balance which is counteracted by the lifting force 17 of the tail propellers 14. It augments the main propeller lift 16 and balances the aircraft to longitudinal equilibrium.

During transition, as the wing moves from vertical to horizontal position, the aircraft's total upwards acting force vector moves aft since the tilt wing 7 will increasingly take over the lifting force generation from the main propellers 11 as the airspeed increases. At the same time the centre of gravity moves forward as the tilt wing 7 tilts forwards such that in cruise configuration the aircraft has a positive static margin and is longitudinally stable. During cruise the aircraft has a nose down pitching moment. Pitch control is provided by the horizontal stabilizer and/or the elevators 18 as in a normal fixed wing aircraft.

The horizontal stabilizer 8 is located under the rear of the fuselage and includes two vertical stabilizers 9 with rudders. The horizontal stabilizer is hinged at the leading edge and is able to tilt upwards 5° and downwards 45° from the horizontal. The horizontal stabilizer 8 is energized by the wash of the main propellers 11 at low airspeeds to provide pitch control during transition. The vertical stabilizers 9 include rudders for yaw control at higher airspeeds.

The tail propellers 14 are a pair of counter rotating propellers providing pitch balance and control at low airspeeds. The counter rotation cancels out the gyroscopic yaw created by each propeller. If only one tail propeller is fitted or post a tail propeller failure, the induced yaw can be reacted by trimming the ailerons on the wing.

The aircraft can be directly controlled by either an onboard or a remote pilot. Main propeller thrust acceleration can be controlled by the collective lever in the left hand of the pilot. Pitch and roll control can by controlled by the pilot using the central cyclic lever in the right hand. Yaw can be controlled by food pedals.

In addition, a switch is provided on the left hand lever for controlling the tilt wing angle. This is used to guide the aircraft safely through the transition corridor. Furthermore, the aircraft is able to be landed conventionally, i.e. with horizontal wings. For this, flap levers are provided which moves the flaps to preset angles for conventional fixed wing take off and landing.

A flaperon is a control surface that combines the function of both flaps and ailerons.

The aircraft is controlled by software and fully fly by wire. Mechanical flight control does not exist. The control device of the aircraft interprets the instructions from the pilot and determines which of the available control surfaces or thrust units are required to deliver the intended response.

FIG. 3 shows a diagram illustrating the transition from hover to cruise through a flight corridor. The horizontal axis is the airspeed [km/h] and the vertical axis is the tilt wing angle [°]. 0° tilt wing angle represents a horizontal tilt wing in cruise and 85° tilt wing angle represents a nearly vertical tilt wing angle in hover. The airspeed in hover is generally 0 km/h.

The upper limit 20 of the corridor defines the maximum flyable decelerated flight condition which is governed by flow separation and control surface effectiveness. The lower limit 21 defines the maximum accelerated flight condition of the corridor. It is governed by the amount of thrust the main propellers provide.

If the aircraft is piloted, the control device 14 restricts the range of the tilt wing angle selectable by the pilot depending on the airspeed. For example, if the aircraft flies with an airspeed of 50 km/h, the pilot can select a tilt wing angle in the range marked by the reference number 22 in FIG. 3, i.e. the pilot can select a tilt wing angle between 22° and 52°. This restriction of the selectable tilt wing angles ensures a safe transition between hover and cruise.

If the aircraft is unpiloted, the control device 15 selects the tilt wing angle defined by the dashed line 23 depending on the airspeed. The dashed line 23 is the centre line between the upper limit 20 and the lower limit 21.

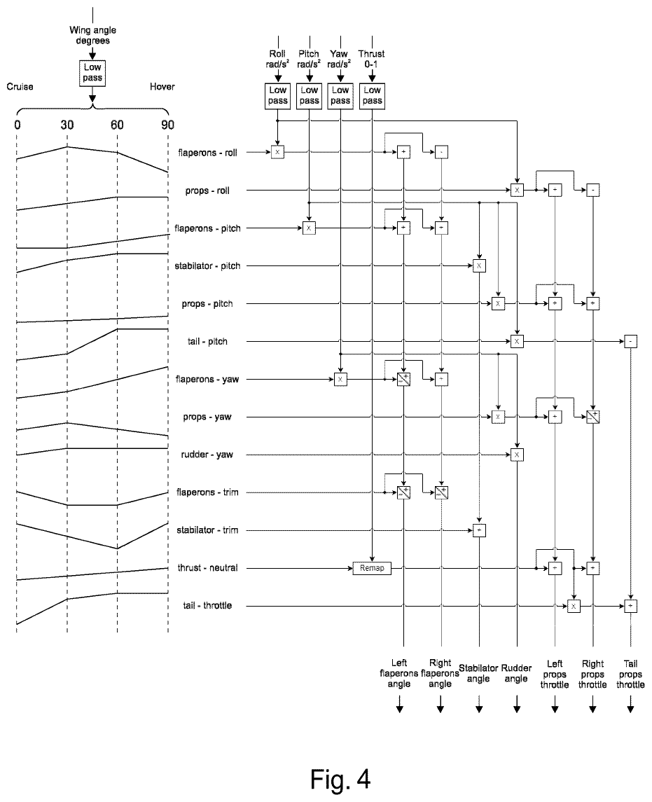

FIG. 4 shows a control schedule of the control device 15. It illustrates how the aircraft is controlled during hover, transition and cruise. Four vertical dashed lines on the left side of the control schedule illustrate the control in different flight conditions, namely 0° tilt wing angle in cruise, 30° tilt wing angle in transition, 60° tilt wing angle in transition and 90° tilt wing angle in hover.

The control schedule illustrates the control of flaperons, propellers (props), stabilator, tail propeller and rudder, collectively referred to as controllable elements. Values for controlling the controllable elements are defined for the mentioned four tilt wing angles. Values for tilt wing angles between these four angles are linearly interpolated, for example. In case of an unpiloted aircraft, the values define a particular value for the control parameter depending on the tilt wing angle. In case of a piloted aircraft, the values define maximum values selectable by the pilot.

The first two curves from above show how the control device 15 controls roll by modulating flaperons 13 and main propellers 11. Roll is controlled during hover by modulating the main propellers 11. The main propellers 11 on one half of the tilt wing 7 are accelerated and the main propellers 11 on the other half of the tilt wing 7 are decelerated. During transition, roll is controlled by modulating the main propellers 11 and the flaperons 13.

Further curves below show how the control device 15 controls pitch by modulating flaperons 13, stabilator 8, main propellers 11 and tail propellers 14. During transition, pitch is controlled by modulating the stabilator 8 and the tail propellers 14. In hover, pitch is controlled by modulating the tail propellers 14.

Further below, curves illustrate the control of yaw by modulating flaperons 13, main propellers 11 and rudder 9. During hover, yaw is controlled by modulating flaperons 13. During transition, yaw is controlled by modulating the main propellers 11 and the rudder 9.

1. An electric vertical take-off and landing aircraft comprising:
a fuselage,
a straight through tilt wing, wherein the straight through tilt wing is tiltable relative to the fuselage in a range of tilt wing angles,
control surfaces arranged at the straight through tilt wing,
a horizontal stabilizer with an elevator, in particular configured as a stabilator,
a vertical stabilizer with a rudder, in particular configured as a fully movable vertical stabilizer
at least one electric engine for powering main propellers arranged at the tilt wing or the pair of tilt wings,
at least one software control device, characterized in that the control device is configured to control at least the control surfaces, the main propellers and the tilt wing angle during
hover, and
transition between hover and cruise flight.

2. The electric vertical take-off and landing aircraft according to claim 1, wherein the control device is configured to control the tilt wing angle during hover and transition depending on the airspeed of the aircraft, in particular wherein
the aircraft is piloted and the control device is configured to restrict the range of the tilt wing angle selectable by the pilot depending on the airspeed of the aircraft, or
the aircraft is unpiloted and the control device is configured to select the value of the tilt wing angle depending on the airspeed of the aircraft.

3. The electric vertical take-off and landing aircraft according to claim 1, wherein the control device is configured to control at least one control parameter during hover and transition depending on the tilt wing angle by defining at least one value, wherein
if the aircraft is piloted, the control device is configured to restrict the range of the at least one control parameter selectable by the pilot depending on the tilt wing angle by defining a minimum selectable value and/or a maximum selectable value, or
if the aircraft is unpiloted, the control device is configured to determine a particular value for the at least one control parameter depending on the tilt wing angle.

4. The electric vertical take-off and landing aircraft according to claim 3, wherein one of the at least one control parameter is a moving position of
the control surfaces arranged at the tilt wing,
the elevator, in particular configured as a stabilator, and/or
the rudder,
wherein the moving position is controlled by the control device during transition depending on the tilt wing angle.

5. The electric vertical take-off and landing aircraft according to claim 3, wherein one of the at least one control parameter is the thrust of the main propellers, wherein the thrust of the main propellers is controlled by the control device during transition depending on the tilt wing angle.

6. The electric vertical take-off and landing aircraft according to claim 3, wherein one of the at least one control parameter is the thrust of a control propeller arranged at the tail of the aircraft, wherein the thrust of the control propeller is controlled by the control device during transition depending on the tilt wing angle.

7. The electric vertical take-off and landing aircraft according to claim 3, wherein the minimum and the maximum value or the particular value of the at least one control parameter are differently defined at least for three different specific tilt wing angles,
in particular wherein values between the specific tilt wing angles are linearly interpolated, and/or
one of the at least three tilt wing angles is the tilt wing angle for cruise and one of the at least three tilt wing angles is the tilt wing angle for hover.

8. The electric vertical take-off and landing aircraft according to claim 3, wherein the at least one value is defined depending on airspeed, angle of attack, side slip, temperature and/or pressure.

9. The electric vertical take-off and landing aircraft according to claim 1, wherein the control device is configured to control roll during hover by modulating the main propellers.

10. The electric vertical take-off and landing aircraft according to claim 1, comprising a control propeller arranged at the tail of the aircraft, wherein the control device is configured to control
pitch during hover by modulating the control propeller, and/or
pitch during transition by modulating the control propeller and/or moving position of the elevator, in particular of the stabilator.

11. The electric vertical take-off and landing aircraft according to claim 1, wherein the control device is configured to control yaw during hover by modulating the ailerons.

12. The electric vertical take-off and landing aircraft according to claim 1, wherein the control device is configured to control roll during transition by modulating the main propellers and the ailerons.

13. The electric vertical take-off and landing aircraft according to claim 1, wherein the control device is configured to control yaw during transition by modulating the main propellers and the rudder.

14. The electric vertical take-off and landing aircraft according to claim 1,
wherein the control device is configured to control the at least one control parameter during hover and transition depending on existence of a failure of an aircraft device,
in particular on the existence of a failure of one of the control surfaces arranged at the tilt wings.
